(19) United States
(12) Patent Application Publication
(10) Pub. No.: US 2012/0008271 A1
(43) Pub. Date: Jan. 12, 2012

(54) METAL LAMINATE VIA IN-MOLD FILM

(75) Inventors: Gurmeet S. Bhutani, Punjab (IN); Li-Chung Liu, Zhongli City (TW)

(73) Assignee: DELL PRODUCTS L.P., Round Rock, TX (US)

(21) Appl. No.: 12/830,691

(22) Filed: Jul. 6, 2010

(51) Int. Cl. G06F 1/16; B32B 37/12; B32B 15/00

(52) U.S. Cl. 361/679.31; 428/457; 428/412; 428/337; 156/242

(57) ABSTRACT

A metal laminate assembly includes a plastic film and a metal film bonded together using a pressure-sensitive adhesive between them. The bonded films may be formed into a desired shape. A plastic part is formed to the bonded films using a single-shot in-mold film molding system. Accordingly, the laminate assembly has the plastic part on a first side and the metal film on a second side, opposite the first side of the assembly.

### BACKGROUND

The present disclosure relates generally to information handling systems (IHSs), and more particularly to a metal laminate via an in-mold film for an IHS.

As the value and use of information continues to increase, individuals and businesses seek additional ways to process and store information. One option is an IHS. An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

An IHS may be configured to be substantially stationary or may be configured to be quite mobile depending its intended use. For each of these types of IHS, the chassis for the IHS is configured to withstand the normal use in its working environment. For example, portable IHSs sometimes have a chassis (e.g., a frame and an outer shell) constructed of plastic, metal, and/or composite materials, which are designed to be light, tough, and small enough to be easily moved from place to place. Some consumers prefer the chassis shell to be formed from metal rather than plastic because the metal shell appears to the consumer to have nicer aesthetics, a more sturdy/durable look and feel, and allows for a thinner profile.

However, there are some limitations to using an entirely metal shell for an IHS. For example, metal shell IHSs may be heavier than their counterpart plastic shell IHSs. Also, due to the heat transfer properties of a thin metal shell, the metal shell IHS may have “hot spots” that feel overly warm to users of the IHS, thereby causing fear in the user that there is a problem with the IHS. Other issues with all metal shells may also exist, such as electric circuit problems if the IHS is dropped and the shell becomes deformed, which may cause electrical circuits to be contacted by the deformed metal shell. If this happens, this can cause an electrical short to the circuits or an electrical potential to be present on the outer metal shell. To combat this, some IHS shells are made of a plastic material, assembled, and then have a metal outer shell layer applied over a painted plastic part using an adhesive at a final assembly stage. Adding such a metal layer after IHS assembly generally has a low production yield due to wrinkles/bubbles formed on the metal outer layer when applying the metal to the IHS. This, in turn, causes a high rework cost to the parts. The metal layer can be made thicker to reduce defects, but doing so requires more metal, which increases the cost and weight of the IHS.

Accordingly, it would be desirable to provide an improved metal-plastic laminate for an IHS outer shell.

### SUMMARY

According to one embodiment, a metal laminate assembly includes a plastic film and a metal film bonded together using a pressure-sensitive adhesive between them. The bonded films may be formed into a desired shape. A plastic part is formed to the bonded films using a single-shot in-mold film molding system. Accordingly, the laminate assembly has the plastic part on a first side and the metal film on a second side, opposite the first side of the assembly.

### BRIEF DESCRIPTION OF THE DRAWINGS

FIG. 1 illustrates a block diagram of an embodiment of an information handling system (IHS).

FIG. 2 illustrates a cut-away view of a portion of an embodiment of a metal-plastic film laminate structure according to the present disclosure.

FIG. 3 illustrates a cut-away view of a portion of an embodiment of a metal-plastic film laminate structure after the structure is formed to shape according to the present disclosure.

FIG. 4 illustrates a cut-away view of a portion of an embodiment of a metal-plastic film laminate structure having a plastic part formed to it according to the present disclosure.

FIG. 5 illustrates a flow chart for an embodiment of a method to form a metal-plastic film laminate structure according to the present disclosure.

FIG. 6 illustrates an embodiment of a roller system to apply an adhesive primer and/or a pigmented layer to films for the metal-plastic film laminate structure according to an embodiment of the present disclosure.

FIG. 7 illustrates an embodiment of a heated laminate roller system to laminate films together according to an embodiment of the present disclosure.

FIG. 8 illustrates an embodiment of a system for trimming a metal-plastic film laminate structure according to an embodiment of the present disclosure.

FIG. 9 illustrates an embodiment of a system for forming a metal-plastic film laminate structure according to an embodiment of the present disclosure.

FIG. 10 illustrates an embodiment of a single-shot in-mold film molding system for forming a plastic part to a metal-plastic film laminate structure according to an embodiment of the present disclosure.

FIG. 11 illustrates an embodiment of a display panel for displaying the single-shot in-mold film molding system of FIG. 10.

FIG. 12 illustrates an embodiment of a metal-plastic film laminate structure and plastic part for a chassis of an IHS according to an embodiment of the present disclosure.

FIG. 13 illustrates an embodiment of an IHS configured using the metal laminated part of FIG. 12.

### DETAILED DESCRIPTION

For purposes of this disclosure, an information handling system (IHS) 100 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS 100 may be a personal computer, a network storage device, or any other suitable device and may vary in size, shape, performance, functionality, and price. The IHS 100 may include random access memory (RAM), one or more processing resources such as a central processing unit (CPU) or hardware or software control logic, read only memory (ROM), and/or other types of nonvolatile memory. Additional components of the IHS 100 may include one or more disk drives, one or more network ports for communicating with external devices as well as various input and output (I/O) devices, such as a keyboard, a mouse, and a video display. The IHS 100 may also include one or more buses operable to transmit communications between the various hardware components.

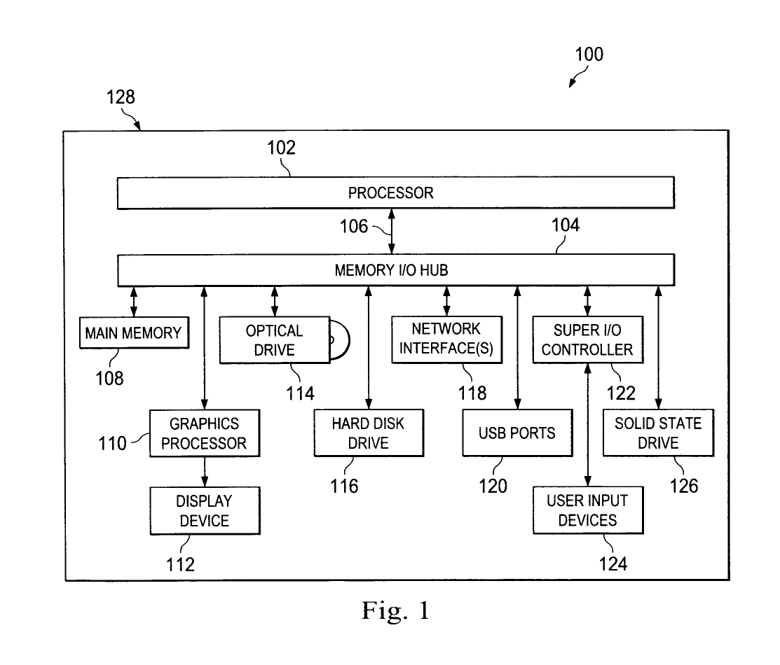

FIG. 1 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in place of, or in addition to main memory 108, the optical drive 114, and/or a hard disk drive 116. It is understood that any or all of the drive devices 114, 116, and 126 may be located locally with the IHS 100, located remotely from the IHS 100, and/or they may be virtual with respect to the IHS 100. The components of the IHS 100 are held together and supported by an IHS chassis 128. The chassis 128 may include a frame and an outer shell.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

The present disclosure provides an improved metal-plastic laminate for an IHS outer shell. In an embodiment, the metal-plastic laminate includes a metal film bonded to a plastic film. This laminate is formed to a shape of the desired outer surface for the IHS shell. A plastic part is molded to the formed metal-plastic laminate. This forms the outer shell part, which has an outer metal layer. Accordingly, the IHS chassis outer shell includes attractive metal on the outside and economical and light-weight plastic on the inside.

The metal-plastic laminate of the present disclosure is formed by laminating a thin (e.g., less than 0.05 mm) metal film (e.g., aluminum, stainless steel, titanium, etc.) to an in-mold label (IML)/in-mold film (IMF)/in-mold decoration (IMD) plastic film. The plastic film may include polycarbonate (PC), acrylonitrile butadiene styrene (ABS), polyethylene terephthalate (PET), material fibers, and/or combinations thereof. However, it should be understood that other films may be used with the present disclosure. In addition, the film may be a pre-painted film or a transparent PC film. A thickness of the metal film may be selected per requirements of secondary process needs such as anodizing, milling, patterning, painting, etc. For example, when the outer shell is to have diamond cut logos or shapes after molding, relatively thicker metal films may be appropriate.

In an embodiment, the metal foil film is laminated together with PC or PET film laminates using heat or glue. These preassembled laminates can be used as regular IML/IMF/IMD film with and without ink or pigment layers on the same or opposite sides. There are many advantages of the metal-plastic laminates of the present disclosure, as should be understood by those having ordinary skill in the art, including, 1) these external metal foils can be pre-coated, anodized or diamond cut as needed; and 2) many metal films can be molded with IMD systems and processes. Furthermore, the metal-plastic laminate parts of the present disclosure can produce high yield parts and offer a low cost solution to an alternative all-metal IHS shell.

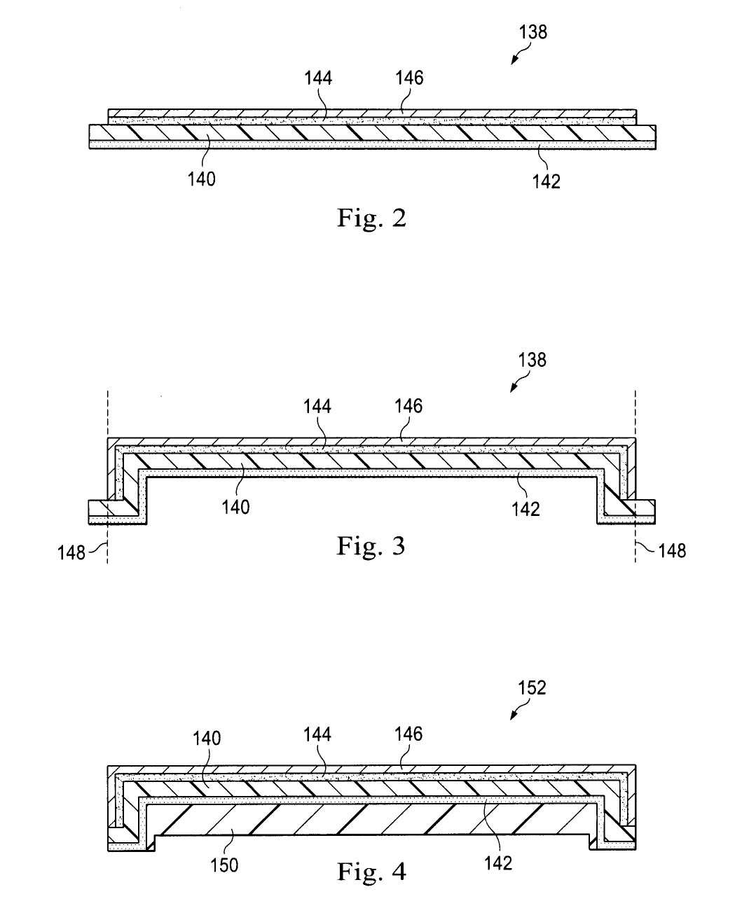

FIG. 2 illustrates a cut-away view of a portion of an embodiment of a metal-plastic film laminate structure assembly 138 according to the present disclosure. The laminate 138 includes a layer of plastic film 140, an optional pigment layer 142, an adhesive layer 144 and a metal film layer 146. The plastic film 140 may be formed of a roll or sheet polycarbonate (PC) film or a polyethylene terephthalate (PET) film and combinations thereof. In addition, other thin plastic films that are suitable for use in IML-type molding systems may be used. The pigment layer 142 may be formed as an ink, paint or other type of pigment such that a transparent plastic film (e.g., film 140) allows the pigment to be seen through the plastic film 140. As such, in-mold labels may be formed by having the label printed on a backside of the plastic film, positioning the plastic film in an IML molding system, and molding the plastic part to the plastic film/pigment layer. The pigment layer 142 may be applied to the film 140 using an ink jet, laser jet, roller system, screen print system or any other type of system of applying a pigment to a film.

The adhesive layer 144 may be a liquid, spray, film, tape or other type of pressure-sensitive adhesive. The metal film 146 may be any metal in a sheet, roll, or other form and may have a thickness between a range of approximately 0.03 mm to 0.05 mm. For example, foil aluminum (Al) may be used with a thickness of approximately 0.05 mm or foil stainless steel may be used with a thickness of approximately 0.03 mm or 0.05 mm. Other metals and/or other thicknesses may be used so long as the metal can withstand the IMF injection molding process temperature of approximately 250° C. In an embodiment, the metal foil 146 may be bonded to the adhesive 144 using a roller or press system, the plastic film 140 may be prepared with an adhesive primer such as a 3M adhesive primer known in the art (not shown), and the foil 146 and the film 140 may be pressed together using a heated roller or press system to bond the laminated assembly 138 together using the adhesive 144.

FIG. 3 illustrates a cut-away view of a portion of an embodiment of the metal-plastic film laminate structure 138 after the structure 138 has been formed to a desired shape. The forming of this assembly 138 may be performed using a press and forming die. In an embodiment, the shape of the assembly 138 is the desired outside shape of the part to assemble the chassis/outer shell of the IHS 100. After forming the assembly 138 to the desired shape, any overhang may be trimmed off, such as at the trim line 148, before molding. In another embodiment, the assembly 138 may be formed and trimmed in a single process step.

An illustration of the formed and trimmed laminate assembly 138 is shown in FIG. 4. Once the assembly 138 is at a desired size and shape, the assembly 138 is placed in a IMF molding die and a plastic part (e.g., part 150) is molded to the assembly 138, thereby creating the metal laminate/molded plastic part 152. In an embodiment, this molded part 152 has the plastic part 150 as the structural internal portion of the part 152 and also has metal foil 146 as an outer layer of the part 152. Thus, upon final assembly of the part 152 to the shell of the IHS 100, the IHS 100 has an appearance of a metal shell with the advantages of a lower cost and a lower weight plastic part.

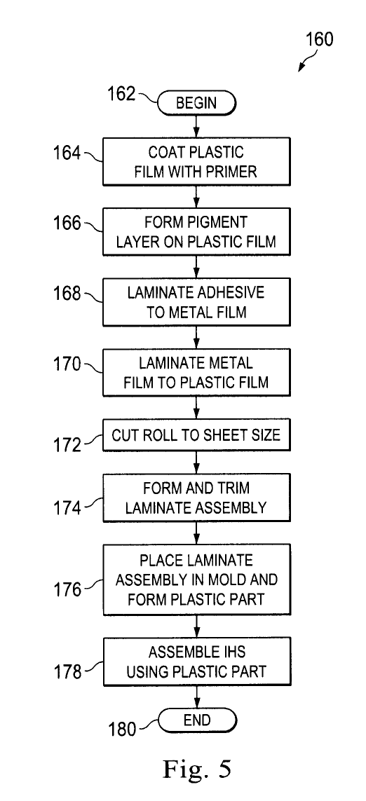

FIG. 5 illustrates a flow chart for an embodiment of a method 160 to form a metal-plastic film laminate structure, such as part 152, according to the present disclosure. The method 160 begins at block 162 where a plastic film (e.g., plastic film 140) and a metal film (e.g., metal film 146) have been provided for processing. The method 160 proceeds to block 164 where the plastic film 140 is coated with an adhesive primer. The adhesive primer may be coated to the plastic film 140 using a roller system, a spray system, a vaporizing system or any other system that can apply the primer to the plastic film 140. The adhesive primer is optional and improves bonding of adhesives (e.g., adhesive 144) to the plastic film 140.

The method 160 then proceeds to block 166 where a pigment layer (e.g. pigment layer 142) is applied to a side of the plastic film 140 opposite that of the adhesive primer. In other words, the plastic film 140 may have an adhesive primer on one side of the film 140 and a pigment layer on the opposite side of the film 140. However, the pigment layer 142 may be unnecessary if the plastic film 140 is not transparent, if the plastic part 150 is the desired color, if the metal foil 146 covers the outer surface of the final part 152, or for any other reason.

The method 160 proceeds to block 168 where an adhesive (e.g., adhesive 144) is bonded/laminated to the metal film 146. The adhesive 144 may be applied as a liquid, paste, sheet, or otherwise to the metal film 146 and may be applied using a spray, roller, press or other type of application system. For example, 3M VHB9469 sheet adhesive provided by the 3M Company, St. Paul, Minn. may be used as an adhesive to laminate the metal film 146 to the plastic film 140 and may be applied using a roller press system. However, other adhesives and/or heat may be used to bond the films 140 and 146 together. The method 160 then proceeds to block 170 where the metal film 146 and the adhesive 144 are bonded/laminated to the plastic film 140. Using the adhesive 144 as a bonding agent, the films 140 and 146 are pressed together using a press, roller system and/or a heat system.

The method 160 then proceeds to block 172 where the metal/plastic film lamination 138 may be cut to an approximate size for forming to the desired shape. The lamination 138 may be cut by hand, machine, or using a variety of other techniques known in the art. In an embodiment, the lamination 138 is constructed of a proper size and does not need to be cut. The method 160 proceeds to block 174 where the lamination 138 is formed into a desired shape/form and trimmed to final desired size. A forming die and press system may be used to receive the laminate 138 and perform the final forming and trimming.

The method 160 then proceeds to block 176 where the laminate 138 is placed in a IMF injection molding die and a plastic part (e.g., part 150) is molded to it. In an embodiment, the plastic part 150 is molded using PC/ABS. In another embodiment, the plastic part 150 is molded using PC/ABS/fiber, however, other materials may be used to form the part 150. The part may be molded at temperatures up to approximately 250° C. and above. Therefore, the laminate assembly 138 should be constructed from materials capable of such temperatures as used in molding the plastic part 150. After the plastic part 150 is molded to the laminate 138, the metal laminate/molded plastic part 152 is removed from the mold. Any final trimming, cleaning, and/or sub assembly may also be performed to the part 150 as desired.

The method then proceeds to block 178 where an IHS (e.g., IHS 100) is assembled, including internal components and the chassis 128, using the metal laminate/molded plastic part 152 as a shell for the chassis 128 of the IHS 100. After assembly of the IHS 100, the method 160 ends at block 180 where the IHS is ready for use or sale and has the desired metal exterior surface over at least a portion of the IHS shell.

FIG. 6 illustrates an embodiment of a roller system 186 used to apply an adhesive primer and/or a pigmented layer (e.g., layer 142) to the films (e.g., 140 and/or 146) for the metal-plastic film laminate structure 152 according to an embodiment of the present disclosure. See also blocks 164 and 166 of FIG. 5. The roller system 186 includes a series of rollers 180 for advancing the film (e.g., 140 or 146) and applying the coating (e.g., adhesive primer, pigment, and etc.) 190 to the film. The roller system 186 advances the coated film past a drying/heating device, such as a heat lamp 192 for drying the coating 190 so that the coated film may be re-rolled or otherwise stored.

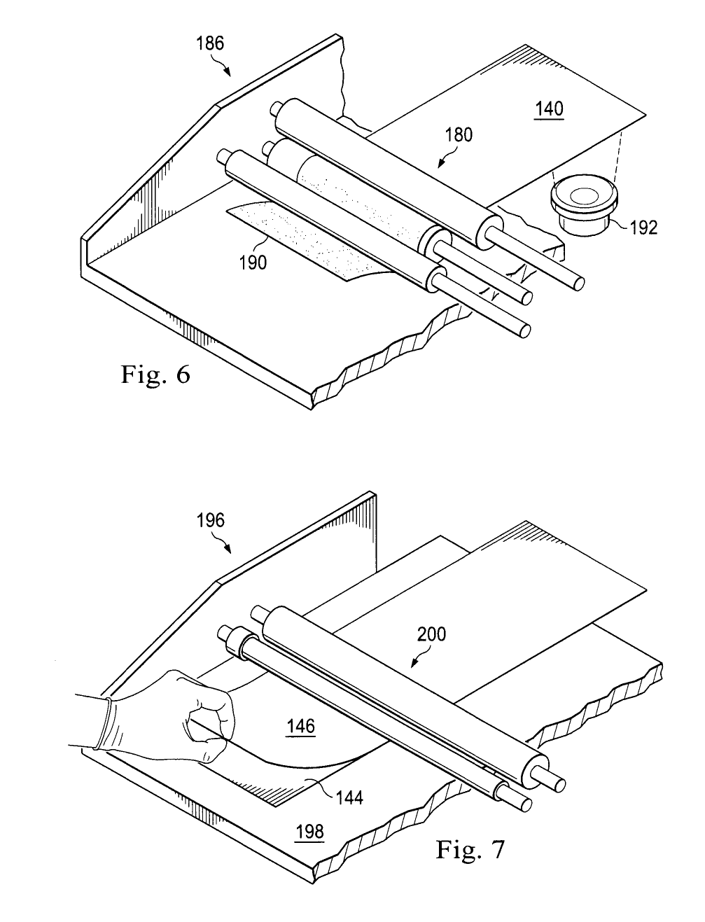

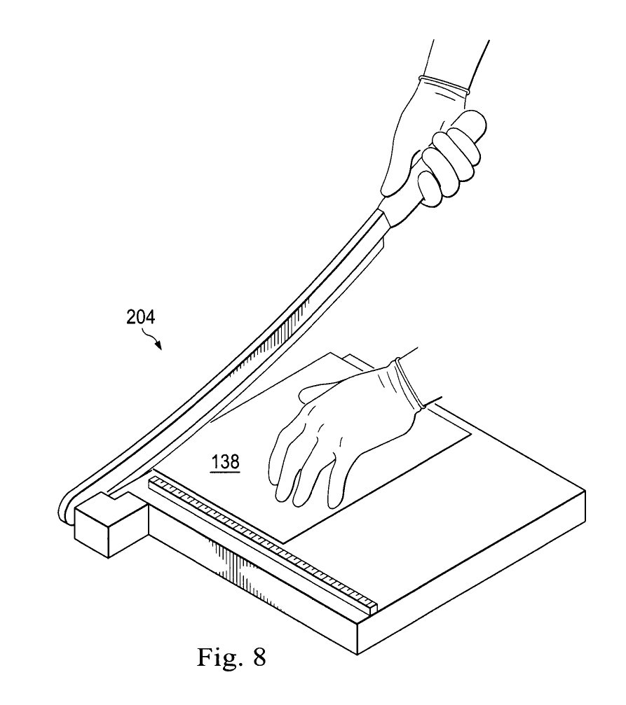

FIG. 7 illustrates an embodiment of a heated laminate roller system 196 to laminate layers (e.g., films 140, 146, adhesives 144, and etc.) together according to an embodiment of the present disclosure. See also FIG. 2 and blocks 168 and 170 of FIG. 5. In an embodiment, the roller system 196 includes a surface 198 and a roller 200 that advances and applies pressure to laminate the films (e.g., 144, 146) together. The surface 198 and/or the roller 200 may be heated to assist in the bonding between the films 144, 146. The roller 200 may be adjustable to apply different amounts of pressure to the laminates 138.

FIG. 8 illustrates an embodiment of a trimming system 204 for trimming the metal-plastic film laminate structure (e.g., 138) according to an embodiment of the present disclosure. See also block 172 of FIG. 5. The trimming system 204 may be used to cut the laminate assembly 138 to a rough size or to a final size for forming. The trimming system may be manually operated or may be computer automated.

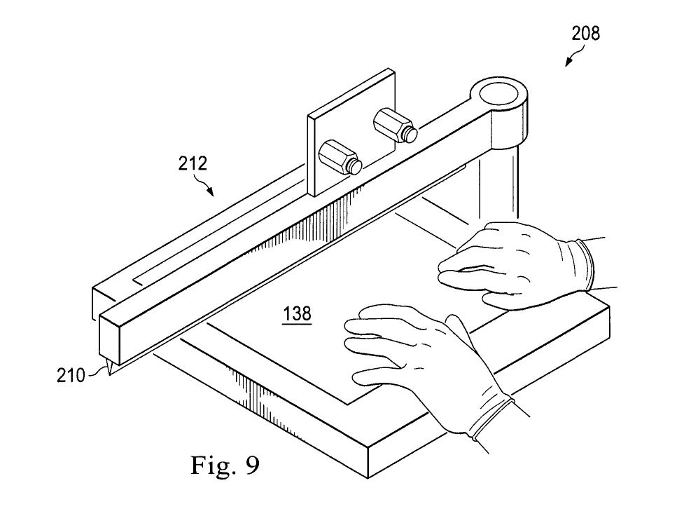

FIG. 9 illustrates an embodiment of a laminate forming system 208 for forming a metal-plastic film laminate structure (e.g., 138) according to an embodiment of the present disclosure. See also FIG. 3 and block 174 of FIG. 5. In an embodiment, the laminate forming system 208 includes a forming/trimming die 210 that operates within an industrial press device 212 to form and/or trim the laminate 138. After the laminate 138 is formed by the die 210, the part 138 is removed and ready for molding of the plastic part 150.

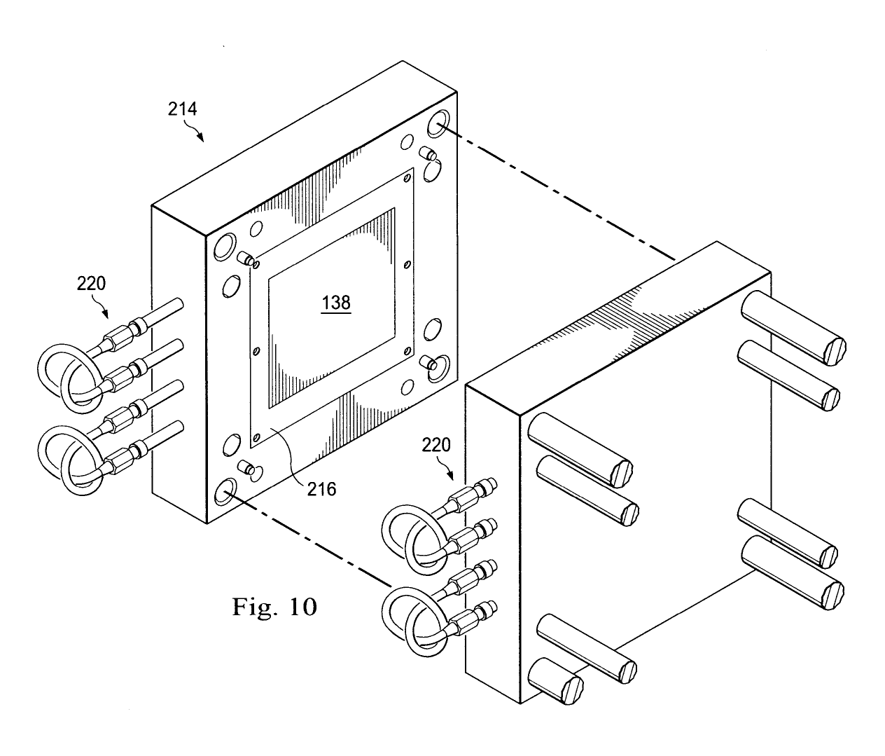

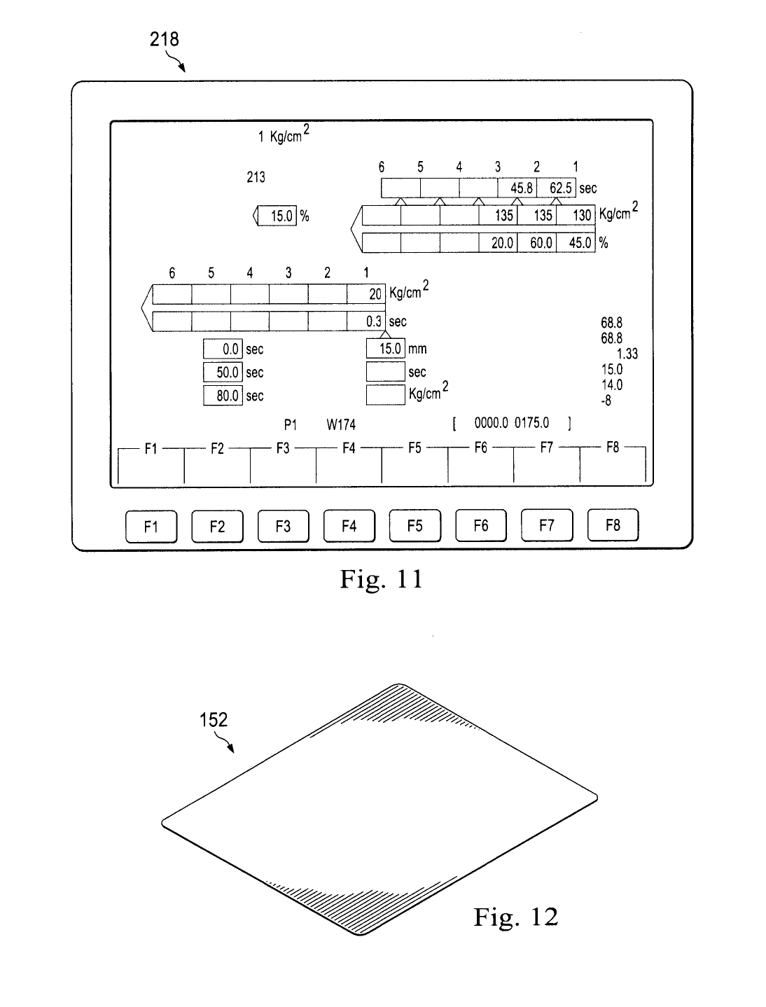

FIG. 10 illustrates an embodiment of a single-shot in-mold film molding system 214 for forming a plastic part (e.g., part 150) to a metal-plastic film laminate structure (e.g. 138) according to an embodiment of the present disclosure. See also FIG. 4 and block 176 of FIG. 5. In an embodiment, the molding system 214 includes a mold 216 that opens to receive the formed laminate 138. A molding system controller device may be operated using a controller display screen 218, illustrated in FIG. 11, to control injection of plastic resin into the mold 216 via one or more resin hoses 220. The mold 216 may be heated, cooled, vented, or otherwise configured to control molding of the plastic part 150 to the laminate 138 to create the IMF part 152, as shown in FIG. 4 and FIG. 12. After the part 150 is formed, the mold 216 opens up allowing removal of the completed part 152.

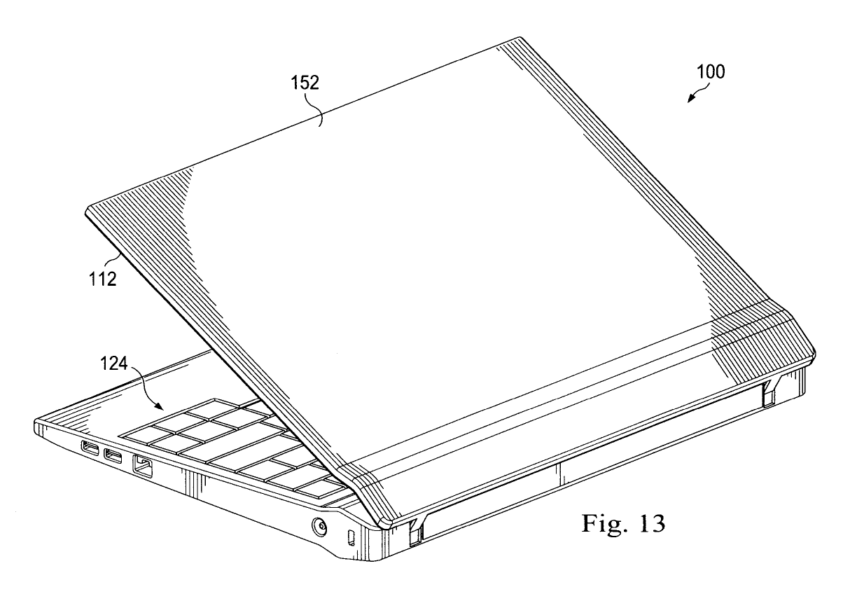

The metal laminated part 152 may then be used in construction of an IHS 100, as shown in block 178 of FIG. 5. FIG. 13 illustrates an embodiment of an IHS configured using the metal laminated part 152 of FIG. 12 as an outer shell for a lid portion of the IHS 100. Other portions of the IHS 100 may be formed using embodiments of the present disclosure.

It should be understood that one or more embodiments of the present disclosure provide a metal outer periphery of an IHS to provide a metal look and feel to an end user, while the inner structure of the parts may be plastic. The metal laminated parts of the present disclosure provide significant weight and cost reductions, as compared to using all metal parts for the outer shell of the IHS. The molding of the metal laminated parts maybe formed using single-shot IMF processes that produce a high-yield for the parts. Various thicknesses of metal foils can be used to facilitate secondary processes to the metal outer surface. For example, the outer metal foil may be processed by color anodizing, diamond cutting, and any variety of aesthetic processing as desired. For example, fine laser etched metal foils with transparent plastic parts can provide a see through metal outer shell through which light can pass.

The present disclosure provides an improved metal-plastic laminate for an IHS outer shell. In an embodiment, the metal-plastic laminate includes a metal film bonded to a plastic film. This laminate is formed to a shape of the desired outer surface for the IHS shell. Then, a plastic part is molded to the formed metal-plastic laminate. This, thereby forms the outer shell part, which has an outer metal layer. Accordingly, the IHS chassis outer shell is attractive metal on the outside and economical and light-weight plastic on the inside. In other words, an embodiment of the present disclosure provides a metal foil that is attached to a plastic (e.g., PC/PET) film using heat or adhesive. This subassembly may be formed into shapes to cover portions of an IHS, such as tops, sidewalls, periphery, etc, as desired. The sub-assembled pre-formed laminate goes into a molding tool and becomes an outer portion of a molded plastic part. As such, the molded plastic part may have an actual metal outer side that causes the IHS to have a metal appearance and feel, using a single-shot IMF molding system.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A laminate assembly comprising:
a plastic film;
a metal film;
a pressure-sensitive adhesive between the plastic film and the metal film, wherein the adhesive bonds the plastic film and the metal film together; and
a plastic part formed to the films using a single-shot in-mold film molding system, thereby forming the laminate assembly to have the plastic part on a first side and the metal film on a second side, opposite the first side of the assembly.

2. The assembly of claim 1, wherein the plastic film comprises polycarbonate (PC) or polyethylene terephthalate (PET) and combinations thereof.

3. The assembly of claim 1, wherein the metal film comprises aluminum or stainless steel.

4. The assembly of claim 1, wherein the adhesive further comprises an adhesive primer formulated to increase bonding strength of the adhesive to the films.

5. The assembly of claim 1, further comprising a pigmented layer between the plastic film and the plastic part.

6. The assembly of claim 1, wherein the metal film has a thickness of approximately 0.03 to approximately 0.05 mm.

7. The assembly of claim 1, wherein the films are laminated together with the adhesive using a heated roller system.

8. An IHS comprising:
a processor;
a memory device coupled to the processor; and
a chassis configured to support the processor and the memory device, wherein the chassis includes, a laminate assembly, the laminate assembly including,
a plastic film;
a metal film;
a pressure-sensitive adhesive between the plastic film and the metal film, wherein the adhesive bonds the plastic film and the metal film together; and
a plastic part formed to the films using a single-shot in-mold film molding system, thereby forming the laminate assembly to have the plastic part on a first side and the metal film on a second side, opposite the first side of the assembly.

9. The IHS of claim 8, wherein the plastic film comprises polycarbonate (PC) or polyethylene terephthalate (PET) and combinations thereof.

10. The IHS of claim 8, wherein the metal film comprises aluminum, stainless steel, or titanium.

11. The IHS of claim 8, wherein the adhesive further comprises an adhesive primer formulated to increase bonding strength of the adhesive to the films.

12. The IHS of claim 8, further comprising a pigmented layer between the plastic film and the plastic part.

13. The IHS of claim 8, wherein the metal film has a thickness of approximately 0.03 to approximately 0.05 mm.

14. The IHS of claim 8, wherein the films are laminated together with the adhesive using a heated roller system.

15. A method of forming a laminate assembly, the method comprising:
providing a plastic film;
coating the plastic film with a layer of adhesive primer;
providing a metal film;
applying a pressure-sensitive adhesive the metal film
bonding the plastic film and the metal film together using the adhesive; and
forming a plastic part to the films using a single-shot in-mold film molding system, thereby forming the laminate assembly having the plastic part on a first side and the metal film on a second side, opposite the first side of the assembly.

16. The method of claim 15, further comprising forming the bonded plastic and metal films into a formed shape using a press die before forming the plastic part to the films.

17. The method of claim 15, further comprising assembling an information handling system (IHS) chassis using the laminate assembly as a part of the chassis such that the metal film is visible on an outside of the chassis.

18. The method of claim 15, further comprising forming a pigmented layer between the plastic film and the plastic part.

19. The method of claim 15, wherein laminating the plastic film and the metal film together using the adhesive and the primer to bond the plastic and metal films together is performed using a heated roller system.

20. The method of claim 15, further comprising forming a design or texture in the metal film.
